(19) United States
(12) Patent Application Publication
(10) Pub. No.: US 2016/0314723 A1
(43) Pub. Date: Oct. 27, 2016

(54) Method of Making Promotional Tags

(71) Applicant: Domtar Paper Company, LLC, Fort Mill, SC (US)

(72) Inventors: John Michael Viavattine, Rochester, NY (US); Jeffrey Rentovich, Rochester, NY (US)

(21) Appl. No.: 15/055,212

(22) Filed: Feb. 26, 2016

Related U.S. Application Data
(60) Provisional application No. 62/126,027, filed on Feb. 27, 2015.

(51) Int. Cl. G09F 3/10; B32B 7/12; G09F 3/02

(52) U.S. Cl. CPC G09F 3/10; G09F 3/02; B32B 7/12; G09F 2003/0226; G09F 2003/0241; B32B 2405/00

(57) ABSTRACT

A composite material, and method of manufacture, are disclosed which facilitate manufacture and printing of promotional tags, or so-called “shelf talkers” or “shelf markers” for retail shelving displays. The composite material comprises a promotional tag layer which may comprise a plurality of individual promotional tags, and at least one pressure-sensitive adhesive tape applied thereto. Cutting regions are provided, whereby individual promotional tags can be formed, each provided with a pressure-sensitive adhesive layer, and an associated, removable release liner. Printing of the promotional information on the composite material is preferably effected by a xerographic printing process, with the pressure-sensitive adhesive selected to facilitate placement of the promotional tags in various retail environments, including room temperature, refrigerated, and freezing temperature environments,

### CROSS-REFERENCE TO RELATED APPLICATIONS

This is a non-provisional application claiming priority to U.S. Provisional Ser. No. 62/126,027, filed on Feb. 27, 2015 entitled “Method of Making Promotional Tags”, which is hereby incorporated by reference in its entirety.

### FEDERALLY SPONSORED RESEARCH OR DEVELOPMENT

Not Applicable.

MICROFICHE/COPYRIGHT REFERENCE

Not Applicable.

### FIELD OF THE INVENTION

The present invention relates generally to a method of making promotional tags, and the resulting composite material, such as in-store price tags, and like product information labels or tags for retail display, and more particularly to a method of making promotional tags such as for product promotions in a retail establishment, by which individual ones of the tags can be readily adhesively affixed to, and removed from product display shelving and like display areas, with the tags being configured for adhesive application at a variety of temperature conditions, such as in freezers, in refrigerated display cases, and on room temperature shelving.

### BACKGROUND OF THE INVENTION

Retail display and sale of merchandise frequently involves providing pricing and promotional information in immediate association with the merchandise, such as on product shelving, in or on product display cases, and the like. The type of “in-store” information, sometimes referred to as “shelf talkers” or “shelf markers”, informs consumers of sales or other promotions, to the benefit of both consumers and retailers.

Heretofore, one method for providing such product information to consumers has involved affixing promotional information or the like on the shelving on which products are displayed for retail sale. To this end, product shelving has typically been configured to include a channel-like cavity which extends along the forward edge of each shelf unit. Product promotional or pricing information has typically been provided on individual card-like elements printed on suitable paper board stock. In order to affix the appropriate promotional element in the desired association with a particular product on display, it has been necessary to manipulate and flex each promotional element, and insert it into the channel-like cavity at the front of the product shelf so that the promotional element is held in captive relationship within the cavity, typically with the upper and lower edges retained within respective upper and lower edge portions of the cavity.

As will be appreciated, insertion and removal of this type of promotional element has proven to be cumbersome and time-consuming. In some retail establishments, product promotions are changed on a weekly basis, thus requiring similar weekly changes of such promotional elements. Considering that some establishments may have dozens or even hundreds of items for which promotions may be beginning or ending, removal and affixing of promotional elements at all of the product display areas can be extremely time-consuming.

While heretofore efforts have been made to provide promotional tags and the like which can be adhesively affixed to display areas, such efforts have not been entirely successful. One problem concerns providing an adhesive compound which is suitable for varying display environments, which may include freezer and refrigerated display areas, in addition to typical room temperature displays. Of course, because such promotional materials are typically regularly changed, any adhesive employed should be selected to leave minimal adhesive residue after removal of the promotional element. Additionally, in view of the typical need to regularly produce a large number of such promotional elements, it is desirable that printing of such elements can be efficiently effected. To this end, use of xerographic printing is particularly desirable for its relatively low cost, high speed, and versatility. However, it is important that any method for providing such promotional tags or labels, including those having adhesive material, avoid creating any undue wear on the typical xerographic printing equipment.

As will be appreciated, the present type of shelf tags or labels are often printed individually for each item on sale, and thus a method of high-speed, variable printing is preferentially used to enable each store to include information such as product name, sale price, discount percentage, original price, and even internal store information such as SKU (shop keeping unit) and barcode for store inventory purposes. The present invention provides a promotional tag or label which will convey the desired information to the customer, which will retain the variable information on the tag (by SKU), and which can be printed variably in high quantity such as by using a xerographic printer.

The present invention is directed to a method of making individual promotional tags or like promotional elements, and the resulting composite material, which addresses drawbacks associated with techniques known heretofore.

### SUMMARY OF THE INVENTION

The present invention contemplates a method of making individual promotional tags, labels, or like promotional elements which are suited to be temporarily affixed to product display shelving or like product display areas. Notably, each individual tag or label is provided with a pressure-sensitive adhesive which promotes efficient placement and removal of the tags in the desired association with products being promoted. In accordance with the present invention, the selected pressure-sensitive adhesive permits use of the flyers at a wide range of temperatures, such that the tags can be readily used in freezer or refrigerated display cases, as well as on shelving or the like at typical room temperatures. Additionally, formation of the individual promotional tags or labels is effected by formation of a composite material which can be efficiently printed on xerographic printing equipment. Versatile and cost-effective use is thus promoted.

The present invention further contemplates the resulting composite material formed in accordance with the present method. The composite material comprises a printable paper layer, and an adhesive layer provided as a means to adhere the shelf tag or label to the store shelf rail. The composite material further includes a removable “backer” sheet or release layer which enables the composite material to be variably printed without causing any jamming or contamination in the associated printing device.

In accordance with the present invention, a method of making individual promotional tags for use on product promotional displays comprises the steps of providing a promotional tag layer comprising paper board stock, and applying at least one pressure-sensitive adhesive tape to the promotional tag layer. The pressure-sensitive adhesive tape comprises a pressure-sensitive adhesive layer which effectively forms a permanent bond with the paper board stock, while forming a temporary bond with a shelving display or the like to which each promotional tag will be affixed.

Notably, the pressure-sensitive adhesive has a width dimension on the paper board stock which is less than a corresponding dimension of each of the individual tags, so that only a portion of each of the individual tags is provided with pressure-sensitive adhesive. Additionally, the pressure-sensitive adhesive tape comprises a release liner layer adhered to and overlying the pressure-sensitive adhesive layer, with release liner layer having a width dimension greater than the width dimension of the pressure-sensitive adhesive layer. The arrangement desirable acts to limit migration of the pressure-sensitive adhesive layer from beneath the release liner layer during printing, and facilitates manual removal of the release liner layer prior to placement of each tag on store shelving.

The formation of individual tags further entails printing the individual promotion tags on the promotional tag layer by xerographic printing, thus providing sheets of the individual tags. Thereafter, the promotional tag layer is cut between adjacent ones of the individual promotional tags, which includes cutting the pressure-sensitive adhesive layer and the release liner layer. Thus, each of the individual tags has a portion of each of the adhesive layer and the release liner layer thereon. To facilitate efficient positioning and attachment of the individual tags to the desired product display shelving or the like, individual ones of the promotional tags are stacked.

As will be appreciated, each of the individual tags is typically dimensioned on the order of several inches along each dimension, although specific dimensions can be smaller or larger as may be desired. In the preferred form, the pressure-sensitive adhesive layer provided on each promotion tag extends generally transversely along the rearwardly facing surface thereof for affixing the tag to an associated shelving display or the like. The pressure-sensitive adhesive is ordinarily provided on an upper portion of the tag so that the tag can hang generally downwardly from the display to which it is affixed by the adhesive.

As noted, in accordance with the preferred practice of the present invention, the pressure-sensitive adhesive is selected to permit affixing of the individual promotional tags to a product display at any one of room temperature, refrigerated temperature, and freezing temperature. The desired positioning of each individual tag is easily effected by removal of the portion of the release liner layer affixed to the pressure-sensitive adhesive layer on each of the tags.

It is presently contemplated that a coated paper board stock can be advantageously employed for the layer on which the tags are printed, but is within the purview of the present invention that an uncoated paper board stock may alternatively be employed.

Thus, practice of the present invention contemplates formation of individual tags for promotional displays by formation of a composite material including a promotional tag layer which can be printed to define a plurality of individual promotion tags positioned in adjacent relationship to each other. The individual promotion tags are delineated from each other by cutting regions defined by the promotional tag layer by which the promotional tag layer can be cut into the individual tags.

The composite material includes at least one pressure-sensitive adhesive tape applied to the promotional tag layer. The pressure-sensitive tape comprises a pressure-sensitive adhesive layer having a width dimension less than a corresponding dimension of each of the individual tags, so that only a portion of each of the individual tags is provided with pressure-sensitive adhesive. The tape further includes a release liner layer or “backer” sheet overlying the pressure-sensitive adhesive layer, wherein the release liner has a width dimension greater than the width dimension of the pressure-sensitive adhesive layer, to thereby limit migration of the pressure-sensitive adhesive layer from beneath the release liner layer.

Individual tags are formed from the composite material by cutting at the cutting, regions. Thereafter, the individual tags can be affixed as desired by removal of the release liner layer to expose the pressure-sensitive adhesive layer on each tag. As noted, the pressure-sensitive adhesive is selected such that exposure of the pressure-sensitive adhesive layer permits application of each of the individual promotion tags to product promotional displays at any one of room temperature, refrigerated temperature and freezing temperature. Additionally, the paper board stock is selected so that the composite material is sufficiently flexible to permit automated xerographic printing of the composite material, including the promotional tag layer, prior to cutting of individual promotional tags.

Other features and advantages of the present invention will become readily apparent from the following detailed description, the accompanying drawings, and the appended claims.

### BRIEF DESCRIPTION OF THE DRAWINGS

FIG. 1 is a perspective view of a promotional tag or label, formed in accordance with the present invention, shown in position on an associated store display shelf;

FIG. 2 is an isometric view of a composite material of promotional tags embodying the principles of the present invention; and

FIG. 3 is a diagrammatic view illustrating a method of making individual promotional tags in accordance with the present invention.

### DETAILED DESCRIPTION

While the present invention is susceptible of embodiment in various forms, there is shown in the drawings and will hereinafter be described a presently preferred embodiment, with the understanding that the present disclosure is to be considered an exemplification of the invention, and is not intended to limit the invention to the specific embodiment illustrated.

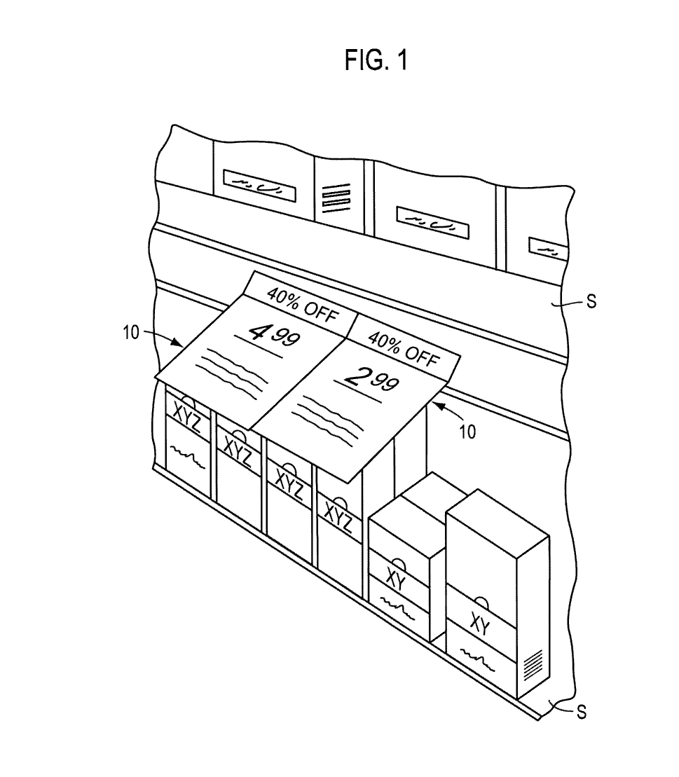

With reference first to FIG. 1, therein is illustrated store shelving S to which a pair of promotional tags or labels 10 embodying the principles of the present invention have been temporarily affixed. As will be recognized by those familiar with the art, these types of promotional tags or labels, which may be alternatively referred to as flyers, “shelf talkers”, or “shelf markers”, provide consumers with information regarding products on display, including promotions, special pricing, product information, and the like.

Efficient and cost-effective use of promotional tags 10 is facilitated by selection of paper board stock which promotes efficient printing of the tags, such as by xerographic printing equipment, and by careful selection of pressure-sensitive adhesive provided on each of the promotional tags 10. Specifically, promotional tags formed in accordance with the present invention preferably include a pressure-sensitive adhesive, with a removable release liner layer or “backer” sheet, which permits the tags to be temporarily affixed in a wide variety of typical retail environments, including room temperature shelving) refrigerated shelving, and freezer shelving, and in environments which may vary from one geographical region to another. Material selection facilitates affixing the tags to store shelving with sufficient strength as to avoid inadvertent dislodgement or removal of the tags, while at the same time permitting convenient removal of the tags, such as at the conclusion of a promotion, with minimal or no adhesive residue remaining in place on the shelving.

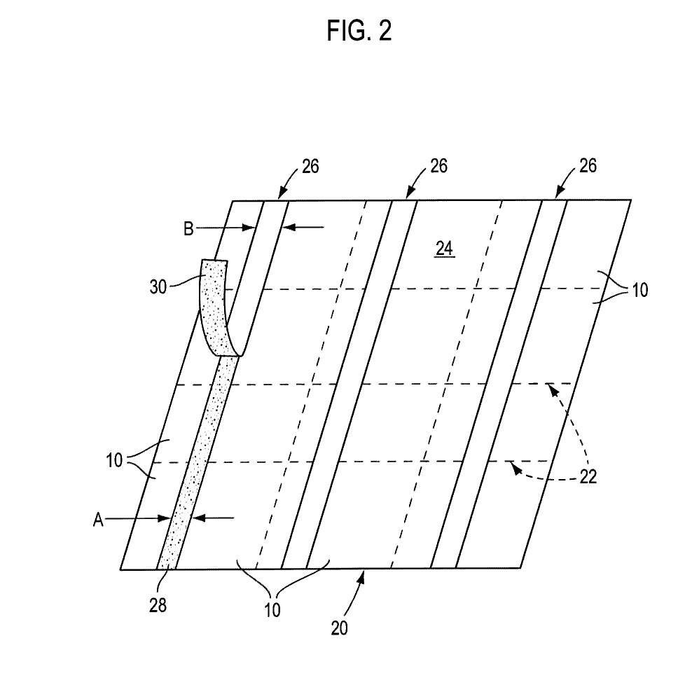

FIG. 2 illustrates a typical configuration of a promotional tag composite material 20 formed in accordance with the present invention As will be observed, composite material 20 can be cut and subdivided at cutting regions 22 to form individual ones of the promotional tags 10, with each of the tags 10 provided with pressure-sensitive adhesive tape applied thereto. More specifically, in the illustrated embodiment, the composite material 20 includes a promotional tag layer 24 comprising paper board stock having selected strength and printing characteristics. As noted, individual promotional tags 10 are delineated from each other by the cutting regions which extend across and through the promotional tag layer 24.

In accordance with the present invention, at least one pressure-sensitive adhesive tape 26 is applied or laminated to the promotional tag layer 24, with three such pressure-sensitive adhesive tapes shown in FIG. 2. The pressure-sensitive adhesive tape comprises a pressure-sensitive adhesive layer 28, and a release liner layer 30 overlying the pressure-sensitive adhesive layer. In the preferred form, the pressure-sensitive adhesive layer 28 had a width dimension A less than a corresponding width dimension of each of the individual tags 10, so that only a portion of each of the individual's tags is provided with pressure-sensitive adhesive. Additionally, the release liner layer overlying each of the pressure-sensitive adhesive layers had a width dimension B greater than the width dimension A of the pressure-sensitive adhesive layer. By this preferred configuration, migration of the pressure-sensitive adhesive layer from beneath the release liner layer is desirably limited, and convenient manual removal of the release liner layer 30 is facilitated.

A particularly desirable feature of the present invention is the selection of a pressure-sensitive adhesive which is suited for use in a wide variety of environments typically encountered in a store or other retail establishment, including refrigerated, freezer, and ambient temperature environments, including ambient environments which may vary geographically, such as between low humidity and high humidity locales. The adhesive is selected to exhibit sufficient adhesive strength to withstand customary foot traffic and expected levels of customer interaction with products on the store shelves, but must permit convenient removal of the promotional tag when desired by the store, and without leaving significant adhesive residue or torn shelf tags which would require significant cleaning.

Formation of the individual promotional tags is effected by cutting the composite material at the cutting regions 22, such that each of the individual tags includes a pressure-sensitive adhesive layer, and a removable, release liner layer. The individual tags can be readily stacked on top of one another, and bundled as may be desired, to facilitate convenient placement in the retail environment. Efficient placement is promoted by bundling the individual promotional tags in a manner which corresponds to their placement on store shelving, such that store employees can very readily select one of the promotional tags, remove the release liner layer thereon, and easily affix the promotion tag to the store shelving by pressing the outwardly-facing, printed surface of the promotional tag such that the rearwardly-facing pressure-sensitive adhesive temporarily secures and affixes the tag to the store shelving, such as shown in FIG. 1.

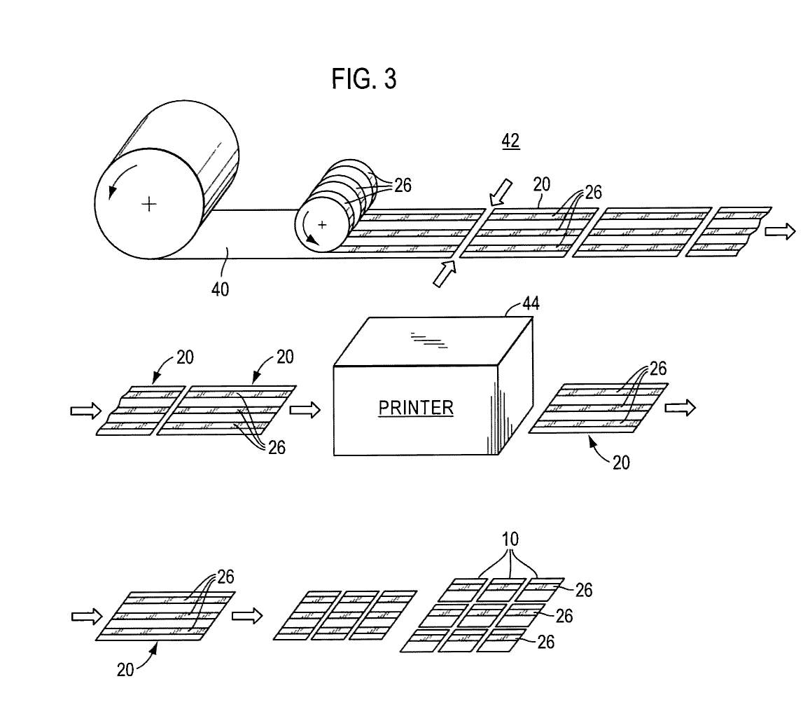

FIG. 3 is a diagrammatic view of the method of making individual promotional tags 10 in accordance with the present invention Paper board stock 40 for formation of the composite material is unrolled, and pressure-sensitive adhesive tape 26 applied thereto, such that the release liner layer 30 of the pressure-sensitive adhesive tape covers the pressure-sensitive adhesive layer 28.

At this stage of production, pieces of the composite material 20 may be suitably stacked, bundled, and the like, for subsequent printing. It is within the purview of the present invention that printing of the promotional information on each piece of composite material can be effected in an in-line process, if desired.

As shown in FIG. 3, individual pieces of the composite material 20 are directed through a suitable printer 44, preferably configured for xerographic printing of the paper board stock 40 from which the composite material is formed, with printing effected on the surface of the paper board stock opposite that surface on which the pressure-sensitive adhesive tape 26 has been applied. Paper board stock 40 is specifically selected to exhibit sufficient flexibility for efficient xerographic printing. Subsequent to printing of the promotional information, each piece of composite material 20 is cut and subdivided at cutting regions 22 (FIG. 2) to form the individual promotional tags 10. As noted, the promotional tags can be then be suitably stacked and bundled, for subsequent placement on retail shelving.

### EXAMPLE

Composite material 20 formed in accordance with the present invention can desirably be configured to be printed on a Xerox iGen Printer that can be configured to effect in-line, post-processing slitting, sheeting, and shrink-packaging for retail store “shelf talker” application. Notably, this product can withstand three different controlled environments, including typical in-store ambient temperature, 72° F., a refrigeration environment at 32° F., and a freezer chest environment at 0° F. Products formed in accordance with the present invention are configured to adhere to retail shelving, without falling off or inadvertent removal, and remain for no longer than two weeks, and must be easily removed, without leaving adhesive residue behind on store shelving. As noted, the release liner layer 30 is selected to have a width dimension greater than the width dimension of the pressure-sensitive adhesive layer to limit adhesive migration. To this end, the adhesive layer preferably has a “dry edge” of no less than 0.062 inches on both edges to eliminate adhesive bleed into the Xerox iGen Printer, and to facilitate liner peel by store associates, which is ordinarily done manually/by hand in the store.

The preferred paper grade for practice of the present invention 8 pt Xerox C1S, available from Domtar Paper Company, which has been developed for toner-based printers. Low reactivity enables performance in 60° F./50% RH to 80° F./80% RH. Stability in printer fusers at the desired environmental ranges is desirably achieved, and the desired resistance to curling is achieved. The preferred paper board specification follows:

| Paper Type | 100# Digital Opaque |
|---|---|
| Basis Weight | 148 gsm |
| Caliper | 7.7 mil |
| Opacity | 97 |
| Brightness | 96 |
| Smoothness (Sheffield) | 130 |

The selected adhesive tape for practicing the present invention is preferably a two-sided, variable acrylic based formulation. The first side thereof effects a permanent bond which comes in contact with the paper board stock. The second side, the release liner side, is repositionable when placed in contact with the store shelving. A presently preferred adhesive is available from the 3M Company, designated 3M9425HT,

Thus, in presently preferred embodiments, the coated paper stock has a basis weight of about 148 gsm, and a caliper of about 7.7 mils. The paper stock preferably has an opacity of about 97, a brightness of about 96, and a Sheffield smoothness of about 130.

From the foregoing, it will be observed that numerous modifications and variations can be effected without departing from the true spirit and scope of the novel concept of the present invention. It is to be understood that no limitation with respect to the specific embodiment illustrated herein is intended or should be inferred. The disclosure is intended to cover, by the appended claims, all such modifications is well within the scope of the claims.

1. A composite material for use on product promotional displays, comprising:
a promotional tag layer comprising a plurality of individual promotional tags positioned in adjacent relationship to each other, said individual promotional tags being delineated from each other by cutting regions defined by said promotional tag layer for cutting said promotional tag layer into said individual tags; and
at least one pressure-sensitive adhesive tape applied to said promotional tag layer, said pressure-sensitive tape comprising a pressure-sensitive adhesive layer having a width dimension less than a corresponding dimension of each of said individual tags, so that only a portion of each of said individual tags is provided with pressure-sensitive adhesive, and a release liner layer overlying said pressure-sensitive adhesive layer, said release liner having a width dimension greater than said width dimension of said pressure-sensitive adhesive layer to limit migration of said pressure-sensitive adhesive layer from beneath said release liner layer,
whereby after cutting, at said cutting regions, the release liner layer can be removed from individual ones of said promotional tags to expose the pressure-sensitive adhesive layer thereon, with exposure of said pressure-sensitive adhesive layer thereafter permitting application of each of said individual promotional tags to product promotional displays at any one of room temperature, refrigerated temperature and freezing temperature,
said composite material being sufficiently flexible to permitted automated xerographic printing of said promotional tag layer prior to cutting of said individual promotional tags.

2. A composite material in accordance with claim 1, wherein
said promotional tag layer comprises coated paper stock.

3. A composite material in accordance with claim 2, wherein said coated paper stock has a, basis weight of about 148 gsm, and a caliper of about 7.7 mil.

4. A composite material in accordance with claim 2, wherein
said coated paper stock has an opacity of about 97, a brightness of about 96, and a Sheffield smoothness of about 130.

5. A composite material in accordance with claim 1, wherein
said pressure-sensitive adhesive tape comprises a two-sided formulation, with a first side thereof forming a permanent bond with said promotional tag layer, and with a second side thereof forming a repositionable bond with an associated product display.

6. A composite material in accordance with claim 5, wherein
said two-sided formulation of said pressure-sensitive adhesive tape comprising a variable acrylic based formulation.

7. A composite material in accordance with claim 1, wherein
each said promotional tag includes a single pressure-sensitive adhesive layer.

8. A method of making individual promotional tags for use on product promotional displays, comprising the steps of:
providing a promotional tag layer comprising paper board stock;
applying at least one pressure-sensitive adhesive tape to said promotional tag layer, said pressure-sensitive adhesive tape comprising a pressure-sensitive adhesive layer having a width dimension less than a corresponding dimension of each of said individual tags, so that only a portion of each of said individual tags is provided with pressure-sensitive adhesive;
said pressure-sensitive adhesive tape further comprising a release liner layer adhered to and overlying said pressure-sensitive adhesive layer, said release liner having a width dimension greater than said width dimension of said pressure-sensitive adhesive layer to limit migration of said pressure-sensitive adhesive layer from beneath said release liner layer;
printing said individual promotional tags on said promotional tag layer by xerographic printing; and
cutting said promotional tag layer between adjacent ones of said individual promotional tags, including cutting said pressure-sensitive adhesive layer and said release liner layer, so that each of said individual tags has a portion of each of said adhesive layer and said release liner layer thereon, and stacking said individual ones of said individual promotional tags,
wherein said pressure-sensitive adhesive layer is selected to permit affixing of said individual promotional tags to a product display at any one of room temperature, refrigerated temperature, and freezing temperature by removal of the portion of said release liner layer thereon.

9. A method making individual tags in accordance with claim 8, wherein said paper board stock comprises coated stock.

10. A method making individual tags in accordance with claim 8, wherein said paper board stock comprises uncoated stock.

11. A method making individual tags in accordance with claim 9, wherein said paper board stock has a basis weight of about 148 gsm, and a caliper of about 7.7 mil.

12. A method making individual tags in accordance with claim 9, wherein
said paper board stock has an opacity of about 97, a brightness of about 96, and a Sheffield smoothness of about 130.

13. A method making individual tags in accordance with claim 8, wherein
said pressure-sensitive adhesive tape comprises a two-sided formulation, with a first side thereof forming a permanent bond with said promotional tag layer, and with a second side thereof forming a repositionable bond with an associated product display.

14. A method making individual tags in accordance with claim 13, wherein
said two-sided formulation of said pressure-sensitive adhesive tape comprising a variable acrylic based formulation.

15. A method making individual tags in accordance with claim 8, wherein
each said promotional tag includes a single pressure sensitive adhesive layer.
